(19) United States
(12) Patent Application Publication
(10) Pub. No.: US 2015/0191362 A1
(43) Pub. Date: Jul. 9, 2015

(54) METHOD OF PURIFYING CALCIUM FLUORIDE

(71) Applicant: Silicor Materials Inc., San Jose, CA (US)

(72) Inventor: Alain Turenne, Kitchener (CA)

(21) Appl. No.: 14/409,545

(22) PCT Filed: Jun. 25, 2013
(86) PCT No.: PCT/US13/47519

§ 371 Date: Dec. 19, 2014

Related U.S. Application Data
(60) Provisional application No. 61/663,877, filed on Jun. 25, 2012.

(51) Int. Cl. C01F 11/22

(52) U.S. Cl. CPC C01F 11/22

(57) ABSTRACT

The present invention provides a method for purifying an inorganic compound, in particular calcium fluoride. The method includes contacting (e.g., washing) the inorganic compound with an aqueous solution, in particular hydrochloric acid.

### RELATED APPLICATIONS

This application claims the benefit of priority to U.S. Provisional Application No. 61/663,877, filed Jun. 25, 2012, which is hereby incorporated by reference in its entirety.

### BACKGROUND

Industrial grade calcium fluoride (CaF₂) contains relatively large amounts of impurities (e.g., phosphorous-containing impurities, aluminum-containing impurities, iron-containing impurities, and/or boron-containing impurities). Higher grades of calcium fluoride are available, but are more expensive. Higher grade calcium fluoride, i.e., calcium fluoride containing lower amounts of impurities, is useful in the manufacturing of upgraded metallurgical-grade (UMG) silicon (also known as UMG-Si), for the production of solar cells. The cost of the upgraded metallurgical-grade silicon is typically dependent upon the nature and amount of impurities present therein.

### SUMMARY

The present invention provides a method for purifying an inorganic compound. For example, at least some of the impurities (e.g., phosphorous-containing substances) can be removed from the inorganic compound. The method includes contacting (e.g., washing) the inorganic compound with an aqueous solution.

The present invention also provides a method for purifying crystalline calcium fluoride (CaF₂) containing phosphorous-containing impurities. The method includes contacting (e.g., washing) the crystalline calcium fluoride (CaF₂) with an aqueous solution that includes, for example, up to about 20 wt. % aqueous hydrochloric acid. The method removes at least some of the phosphorous-containing impurities from the crystalline calcium fluoride (CaF₂).

### DETAILED DESCRIPTION

Reference will now be made in detail to certain claims of the disclosed subject matter, examples of which are illustrated in the accompanying structures and formulas. While the disclosed subject matter will be described in conjunction with the enumerated claims, it will be understood that they are not intended to limit the disclosed subject matter to those claims. On the contrary, the disclosed subject matter is intended to cover all alternatives, modifications, and equivalents, which may be included within the scope of the presently disclosed subject matter as defined by the claims.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the methods described herein, the steps can be carried out in any order without departing from the principles of the disclosed subject matter, except when a temporal or operational sequence is explicitly recited. Recitation in a claim to the effect that first a step is performed, then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The presently disclosed subject matter relates to methods for purifying an inorganic compound. When describing the methods for purifying an inorganic compound, the following terms have the following meanings, unless otherwise indicated.

### Definitions

Unless stated otherwise, the following terms and phrases as used herein are intended to have the following meanings:

As used herein, “contacting” refers to the act of touching, making contact, or of immediate proximity. In specific embodiments, the contacting includes washing. The contacting will typically include a “residence time.”

As sued herein, “residence time” refers to the length of time in which the substances will contact one another. Each of the first aqueous solution and the second aqueous solution will independently have a residence time. Suitable residence times include, e.g., at least about 10 minutes. For example, the first aqueous solution can have a residence time of at least about 10 minutes (e.g., about 1-2 hours), and the second aqueous solution can have a residence time of at least about 10 minutes (e.g., about 15-30 minutes).

As used herein, “washing” refers to the process of purifying a solid mass (e.g., crystals) by passing a liquid over and/or through the solid mass, as to remove soluble matter. The process includes passing a solvent, such as dilute mineral acid or distilled water, over and/or through a precipitate obtained from filtering, decanting, or a combination thereof. For example, in one embodiment, washing includes contacting solids with dilute mineral acid or water, vigorously shaking, agitating, mixing or stirring (e.g., for up to about two hours), and separating (e.g, filtering or decanting). The solvent can be water, can be an aqueous solvent system, or can be a dilute mineral acid. As such, the term includes “rinsing,” which utilizes water as the sole solvent. Additionally, the washing can be carried out with the solvent having any suitable temperature. For example, the washing can be carried out with the solvent having a temperature between about 0° C. and about 120° C., or between about 5° C. and about 75° C. The washing can be carried out for any suitable number of times, e.g., one, two, three, four, five, etc. number of times. Specifically, the solid mass (e.g., crystals) can be washed with the first aqueous solution for a suitable number of times, e.g., one, two, three, four, five, etc., and can independently be washed with the second aqueous solution for a suitable number of times, e.g., one, two, three, four, five, etc.

As used herein, “mineral acid” refers to an acid derived from one or more inorganic compounds. A mineral acid is not organic and all mineral acids release hydrogen ions when dissolved in water.

As used herein, “separating” refers to the process of removing solids from a mixture. The process can employ any technique known to those of skill in the art, e.g., decanting the mixture, filtering the solids from the mixture, or a combination thereof

As used herein, “filtering” refers to the process of removing solids from a mixture by passing the liquid through a filter, thereby suspending the solids on the filter.

As used herein, “decanting” refers to the process of pouring off a liquid without disturbing the sediment, or the process of pouring off a liquid with a minimal disturbance of the sediment.

As used herein, “drying” includes removing a substantial portion (e.g., more than 90 wt. %) of the organic solvent and water present therein. The drying can include the removal of water and/or solvent, such that the water and/or solvent content is below about 5 wt. %, below about 2 wt. % or below about 1 wt. %.

As used herein, “purifying” refers to the process of ridding a solid substrate (e.g., crystals) of impurities. Suitable methods of purifying include, e.g., washing and drying.

Obviously, numerous modifications and variations of the presently disclosed subject matter are possible in light of the above teachings. It is therefore to be understood that within the scope of the appended claims, the disclosed subject matter may be practiced otherwise than as specifically described herein.

Specific ranges, values, and embodiments provided below are for illustration purposes only and do not otherwise limit the scope of the disclosed subject matter, as defined by the claims. The specific ranges, values, and embodiments described below encompass all combinations and sub-combinations of each disclosed range, value, and embodiment, whether or not expressly described as such.

### Specific Ranges, Values, and Embodiments

In specific embodiments, the inorganic compound is an amorphous powder. In other specific embodiments, the inorganic compound is a crystalline solid.

In specific embodiments, the inorganic compound includes at least one of calcium chloride, calcium bromide, calcium iodide, beryllium fluoride, magnesium fluoride, strontium fluoride, barium fluoride and calcium fluoride. In further specific embodiments, the inorganic compound is calcium fluoride (CaF₂).

In specific embodiments, the inorganic compound has a solubility in water, at 20° C., of less than about 0.0050 g/100 mL. In further specific embodiments, the inorganic compound has a solubility in water, at 20° C., of less than about 0.0025 g/100 mL. In further specific embodiments, the inorganic compound has a solubility in water, at 20° C., of less than about 0.0020 g/100 mL.

In specific embodiments, the inorganic compound has a solubility in 1 wt. % hydrochloric acid, at 20° C., of less than about 0.0050 g/100 mL. In further specific embodiments, the inorganic compound has a solubility in 1 wt. % hydrochloric acid, at 20° C., of less than about 0.0025 g/100 mL. In further specific embodiments, the inorganic compound has a solubility in 1 wt. % hydrochloric acid, at 20° C., of less than about 0.0020 g/100 mL.

In specific embodiments, the crude inorganic compound includes at least about 50 ppm impurities. In further specific embodiments, the crude inorganic compound includes at least about 50 ppm impurities. In further specific embodiments, the crude inorganic compound includes up to about 750 ppm impurities. In further specific embodiments, the crude inorganic compound includes about 100-200 ppm impurities.

In specific embodiments, the crude inorganic compound includes at least one of phosphorous-containing impurities, aluminum-containing impurities, iron-containing impurities, and boron-containing impurities.

In specific embodiments, the crude inorganic compound includes at least about 100 ppm phosphorous-containing impurities. In further specific embodiments, the crude inorganic compound includes up to about 750 ppm phosphorous-containing impurities. In further specific embodiments, the crude inorganic compound includes about 100-200 ppm phosphorous-containing impurities.

In specific embodiments, at least one of the impurities has a solubility in water, at 20° C., of greater than about 0.0025 g/100 mL. In further specific embodiments, at least one of the impurities has a solubility in water, at 20° C., of greater than about 0.0050 g/100 mL. In further specific embodiments, at least one of the impurities has a solubility in water, at 20° C., of greater than about 0.010 g/100 mL. In further specific embodiments, at least one of the impurities has a solubility in water, at 20° C., of greater than about 0.10 g/100 mL.

In specific embodiments, at least one of the impurities has a solubility in 1 wt. % hydrochloric acid, at 20° C., of greater than about 0.0025 g/100 mL. In further specific embodiments, at least one of the impurities has a solubility in 1 wt. % hydrochloric acid, at 20° C., of greater than about 0.0050 g/100 mL. In further specific embodiments, at least one of the impurities has a solubility in 1 wt. % hydrochloric acid, at 20° C., of greater than about 0.010 g/100 mL. In further specific embodiments, at least one of the impurities has a solubility in 1 wt. % hydrochloric acid, at 20° C., of greater than about 0.10 g/100 mL.

In specific embodiments, the washing of the inorganic compound with the aqueous solution includes at least one of shaking, agitating, mixing and stirring of the inorganic compound and the aqueous solution. In further specific embodiments, the washing of the inorganic compound with the aqueous solution includes mixing the inorganic compound and the aqueous solution.

In specific embodiments, the washing is carried out with the aqueous solution having a temperature between about 5° C. and about 75° C. In specific embodiments, the washing is carried out with the aqueous solution having a temperature between about 10° C. and about 50° C. In specific embodiments, the washing is carried out with the aqueous solution having a temperature between about 15° C. and about 25° C.

In specific embodiments, the aqueous solution includes at least one mineral acid. Suitable mineral acids include, e.g., sulfuric acid (H₂SO₄), hydrogen chloride (HCl), phosphoric acid (H₃PO₄), and nitric acid (HNO₃). In further specific embodiments, the aqueous solution includes hydrogen chloride (HCl), alternatively referred to as hydrochloric acid (HCl).

In specific embodiments, the at least one mineral acid can include up to about 6N aqueous hydrochloric acid.

In specific embodiments, the at least one mineral acid can include about 1 wt. % to about 50 wt. % aqueous hydrochloric acid.

In specific embodiments, the at least one mineral acid can include about 10 wt. % to about 20 wt. % aqueous hydrochloric acid.

In specific embodiments, the inorganic compound is separated from the aqueous solution.

In specific embodiments, the inorganic compound is washed with a second aqueous solution. In further specific embodiments, the inorganic compound is washed with a second aqueous solution, to remove mineral acid from the inorganic compound. In further specific embodiments, the second aqueous solution can be water (e.g., distilled water).

In specific embodiments, the inorganic compound is separated from the second aqueous solution.

In specific embodiments, the washing of the inorganic compound with the second aqueous solution includes at least one of shaking, agitating, mixing and stirring of the inorganic compound and the second aqueous solution. In further specific embodiments, the washing of the inorganic compound with the second aqueous solution includes mixing the inorganic compound and the second aqueous solution.

In specific embodiments, the washing is carried out with the second aqueous solution having a temperature between about 5° C. and about 75° C. In specific embodiments, the washing is carried out with the second aqueous solution having a temperature between about 10° C. and about 50° C. In specific embodiments, the washing is carried out with the second aqueous solution having a temperature between about 15° C. and about 25° C.

In specific embodiments, the purified inorganic compound includes less than about 50 ppm phosphorous-containing impurities. In further specific embodiments, the purified inorganic compound includes less than about 10 ppm phosphorous-containing impurities. In further specific embodiments, the purified inorganic compound includes less than about 5 ppm phosphorous-containing impurities.

In specific embodiments, the purified inorganic compound is at least about 99.9 wt. % pure. In further specific embodiments, the purified inorganic compound is at least about 99.99 wt. % pure. In specific embodiments, the purified inorganic compound is at least about 99.999 wt. % pure. In further specific embodiments, the purified inorganic compound is at least about 99.9999 wt. % pure. In further specific embodiments, the purified inorganic compound is at least about 99.99999 wt. % pure.

In specific embodiments, up to about 99 wt. % of phosphorous-containing impurities are removed from the inorganic compound. In further specific embodiments, at least about 10 wt. % of phosphorous-containing impurities are removed from the inorganic compound. In further specific embodiments, at least about 20 wt. % of phosphorous-containing impurities are removed from the inorganic compound. In further specific embodiments, at least about 30 wt. % of phosphorous-containing impurities are removed from the inorganic compound. In further specific embodiments, at least about 40 wt. % of phosphorous-containing impurities are removed from the inorganic compound. In further specific embodiments, at least about 50 wt. % of phosphorous-containing impurities are removed from the inorganic compound. In further specific embodiments, at least about 60 wt. % of phosphorous-containing impurities are removed from the inorganic compound. In further specific embodiments, at least about 70 wt. % of phosphorous-containing impurities are removed from the inorganic compound. In further specific embodiments, at least about 80 wt. % of phosphorous-containing impurities are removed from the inorganic compound. In further specific embodiments, at least about 90 wt. % of phosphorous-containing impurities are removed from the inorganic compound. In further specific embodiments, at least about 95 wt. % of phosphorous-containing impurities are removed from the inorganic compound.

In specific embodiments, the first aqueous solution has a residence time of at least about 1 hour. In further specific embodiments, the first aqueous solution has a residence time of at least about 2 hours. In further specific embodiments, the first aqueous solution has a residence time of about 30 minutes to about 150 minutes. In further specific embodiments, the first aqueous solution has a residence time of up to about 5 hours. In further specific embodiments, the first aqueous solution has a residence time of about 1-2 hours.

In specific embodiments, the second aqueous solution has a residence time of at least about 5 minutes. In further specific embodiments, the second aqueous solution has a residence time of at least about 10 minutes. In further specific embodiments, the second aqueous solution has a residence time of about 5 minutes to about 60 minutes. In further specific embodiments, the second aqueous solution has a residence time of up to about 2 hours. In further specific embodiments, the second aqueous solution has a residence time of about 15-30 minutes.

In specific embodiments, the inorganic solid is washed once with the first aqueous solution. In additional specific embodiments, the inorganic solid is washed twice with the first aqueous solution. In additional specific embodiments, the inorganic solid is washed three times with the first aqueous solution. In additional specific embodiments, the inorganic solid is washed two or more times with the first aqueous solution. In additional specific embodiments, the inorganic solid is washed up to five times with the first aqueous solution.

In specific embodiments, the inorganic solid is washed once with the second aqueous solution. In additional specific embodiments, the inorganic solid is washed twice with the second aqueous solution. In additional specific embodiments, the inorganic solid is washed three times with the second aqueous solution. In additional specific embodiments, the inorganic solid is washed two or more times with the second aqueous solution. In additional specific embodiments, the inorganic solid is washed up to five times with the second aqueous solution.

In specific embodiments, the purified inorganic solid is obtained in up to about a 99 wt. % yield. In additional specific embodiments, the purified inorganic solid is obtained in up to about a 90 wt. % yield. In additional specific embodiments, the purified inorganic solid is obtained in up to about a 85 wt. % yield. In additional specific embodiments, the purified inorganic solid is obtained in up to about a 80 wt. % yield. In additional specific embodiments, the purified inorganic solid is obtained in up to about a 75 wt. % yield. In additional specific embodiments, the purified inorganic solid is obtained in up to about a 70 wt. % yield. In additional specific embodiments, the purified inorganic solid is obtained in up to about a 65 wt. % yield.

In specific embodiments, the purified inorganic solid is obtained in at least about a 65 wt. % yield. In additional specific embodiments, the purified inorganic solid is obtained in at least about a 70 wt. % yield. In additional specific embodiments, the purified inorganic solid is obtained in at least about a 75 wt. % yield. In additional specific embodiments, the purified inorganic solid is obtained in at least about a 80 wt. % yield. In additional specific embodiments, the purified inorganic solid is obtained in at least about a 85 wt. % yield.

The washing can be carried out for any suitable number of times, e.g., one, two, three, four, five, etc. number of times. Specifically, the solid mass (e.g., crystals) can be washed with the first aqueous solution for a suitable number of times, e.g., one, two, three, four, five, etc., and can independently be washed with the second aqueous solution for a suitable number of times, e.g., one, two, three, four, five, etc.

Specific enumerated embodiments [1] to [29] provided below are for illustration purposes only, and do not otherwise limit the scope of the disclosed subject matter, as defined by the claims. These enumerated embodiments encompass all combinations, sub-combinations, and multiply referenced (e.g., multiply dependent) combinations described therein.

### Enumerated Embodiments

[1.] A method for purifying an inorganic compound, the method comprising washing the inorganic compound with an aqueous solution.

[2.] The method of embodiment [1], wherein the inorganic compound is an amorphous powder.

[3.] The method of any one of embodiments [1] to [2], wherein the inorganic compound is a crystalline solid.

[4.] The method of any one of embodiments [1] to [3], wherein the inorganic compound comprises at least one of calcium chloride, calcium bromide, calcium iodide, beryllium fluoride, magnesium fluoride, strontium fluoride, barium fluoride and calcium fluoride.

[5.] The method of any one of embodiments [1] to [4], wherein the inorganic compound comprises calcium fluoride (CaF₂).

[6.] The method of any one of embodiments [1] to [5], wherein the inorganic compound has a solubility in water, at 20° C., of less than about 0.0020 g/100 mL.

[7.] The method of any one of embodiments [1] to [6], wherein the inorganic compound comprises at least about 100 ppm impurities.

[8.] The method of any one of embodiments [1] to [7], wherein the inorganic compound comprises up to about 750 ppm impurities.

[9.] The method of any one of embodiments [1] to [8], wherein the inorganic compound comprises at least one of phosphorous-containing impurities, aluminum-containing impurities, iron-containing impurities, and boron-containing impurities.

[10.] The method of any one of embodiments [1] to [9], wherein the starting inorganic compound comprises at least about 100 ppm phosphorous-containing impurities.

[11.] The method of any one of embodiments [1] to [10], wherein the inorganic compound comprises about 100-200 ppm phosphorous-containing impurities.

[12.] The method of any one of embodiments [7] to [11], wherein at least one of the impurities has a solubility in water, at 20° C., of greater than about 0.0025 g/100 mL.

[13.] The method of any one of embodiments [1] to [12], wherein the washing of the inorganic compound with the aqueous solution comprises mixing the inorganic compound and the aqueous solution.

[14.] The method of any one of embodiments [1] to [13], further comprising washing the purified inorganic compound with a second aqueous solution, to remove mineral acid from the purified inorganic compound.

[15.] The method of any one of embodiments [1] to [14], further comprising washing the purified inorganic compound with water, to remove mineral acid from the purified inorganic compound.

[16.] The method of any one of embodiments [1] to [15], further comprising separating the aqueous solution from the purified inorganic compound.

[17.] The method of any one of embodiments [14] to [15], further comprising separating the second aqueous solution from the purified inorganic compound.

[18.] The method of any one of embodiments [1] to [17], wherein the aqueous solution comprises at least one mineral acid.

[19.] The method of any one of embodiments [1] to [18], wherein the aqueous solution comprises hydrogen chloride (HC1).

[20.] The method of any one of embodiments [1] to [19], wherein the aqueous solution comprises up to about 6 N aqueous hydrochloric acid.

[21.] The method of any one of embodiments [1] to [20], wherein the aqueous solution comprises about 1 wt. % to about 50 wt. % aqueous hydrochloric acid.

[22.] The method of any one of embodiments [1] to [21], wherein the aqueous solution comprises about 10 wt. % to about 20 wt. % aqueous hydrochloric acid.

[23.] The method of any one of embodiments [1] to [22], wherein the purified inorganic compound comprises less than about 10 ppm phosphorous-containing impurities.

[24.] The method of any one of embodiments [1] to [23], wherein the purified inorganic compound comprises less than about 5 ppm phosphorous-containing impurities. [25.] The method of any one of embodiments [1] to [24], wherein the purified inorganic compound is at least about 99.99 wt. % pure.

[26.] The method of any one of embodiments [1] to [25], wherein the purified inorganic compound is at least about 99.999 wt. % pure.

[27.] The method of any one of embodiments [1] to [26], wherein the inorganic compound is washed with the aqueous solution by shaking, agitating, mixing or stirring.

[28.] The method of any one of embodiments [1] to [27], wherein the washing is carried out with the aqueous solution having a temperature between about 5° C. and about 75° C.

[29.] A method for purifying crystalline calcium fluoride (CaF₂) containing at least about 100 ppm phosphorous-containing impurities, the method comprising washing the crystalline calcium fluoride (CaF₂) with an aqueous solution comprising up to about 20 wt. % aqueous hydrochloric acid, to remove at least some of the phosphorous-containing impurities from the crystalline calcium fluoride (CaF₂), wherein the purified inorganic compound comprises less than about 10 ppm phosphorous-containing impurities.

[30.] A method for purifying crystalline calcium fluoride (CaF₂) containing phosphorous-containing impurities, the method comprising washing the crystalline calcium fluoride (CaF₂) with an aqueous solution comprising acid, to remove at least some of the phosphorous-containing impurities from the crystalline calcium fluoride (CaF₂).

[31.] The method of embodiment [30], wherein the crystalline calcium fluoride (CaF₂) comprises at least about 100 ppm phosphorous-containing impurities.

[32.] The method of any one of embodiment [30] to [31], wherein the aqueous solution comprising the acid is aqueous hydrochloric acid.

[33.] The method of any one of embodiment [30] to [32], wherein the aqueous solution comprising the acid is about 5-20 wt. % mineral acid.

[34.] The method of any one of embodiment [30] to [33], wherein the aqueous solution comprising the acid is about 5-20 wt. % aqueous hydrochloric acid.

[35.] The method of any one of embodiment [30] to [34], wherein the purified inorganic compound comprises up to about 10 ppm phosphorous-containing impurities.

The present invention can be illustrated by the following, non-limiting example.

### EXAMPLE 1

A 200 gal cone-bottom polyethylene tank was filled with approximately 60 L of tap water (approximately 15° C.), and was mixed with a single 8″ propeller pneumatic mixer. Approximately 68 kg of calcium fluoride (3 bags) was added to the agitating water. The mixer speed was adjusted to keep the calcium fluoride in suspension. A tank lid, with top draft ventilation was placed on the cone bottom tank, and 60 L of 29% hydrochloric acid (ambient temp.) was added to the water/CaF₂ mixture at a rate of about 4 L/min. These components were mixed continuously for approximately 2 hours with the propeller mixer in the cone bottom tank. The mixer was stopped, and the mixture was allowed to settle for 1 hour. The lid was removed, and the liquid was decanted from the top using an air operated double diaphragm pump, and manually manipulated hoses. The lid was replaced, and approximately 120 L of tap water (15° C.) was added to the wet calcium fluoride, which was again put into suspension using the mixer. These components were mixed continuously for approximately 1/2 hour. The mixer was stopped and the mixture was allowed to settle for 1 hour. The lid was removed, the water was decanted from the top, and the lid was replaced. Approximately 120 L of tap water (˜15° C.) was again added to the tank, and mixed for 1/2 hr. The calcium fluoride was kept in suspension using the mixer, while the mixture was removed through the bottom of the cone bottom tank, and pumped into a fused silica drying crucible. The mixture was allowed to settle for approximately 1 hr in the crucible, after which the liquid was decanted from the top using the AODD pump. The crucible was heated in an electric resistance heated oven to 500° C. for approximately 12 hours to evaporate remaining water. The hard-packed top crust was removed and discarded, as it has been shown to be higher (nearly 10×) in impurity concentrations. The less dense bed of calcium fluoride below was removed, crushed or broken back into a powder, mixed and then tested for impurity concentrations.

All publications, patents, and patent applications are incorporated herein by reference. While in the foregoing specification this disclosed subject matter has been described in relation to certain preferred embodiments thereof, and many details have been set forth for purposes of illustration, it will be apparent to those skilled in the art that the disclosed subject matter is susceptible to additional embodiments and that certain of the details described herein may be varied considerably without departing from the basic principles of the disclosed subject matter.

1. A method for purifying an inorganic compound comprising at least one of calcium chloride, calcium bromide, calcium iodide, beryllium fluoride, magnesium fluoride, strontium fluoride, barium fluoride and calcium fluoride, the inorganic compound comprising at least about 100 ppm impurities, the method comprising washing the inorganic compound with an aqueous solution comprising an acid.

2. The method of claim 1, wherein the inorganic compound is an amorphous powder or a crystalline solid.

3-4. (canceled)

5. The method of claim 1, wherein the inorganic compound comprises calcium fluoride (CaF₂).

6. The method of claim 1, wherein the inorganic compound has a solubility in water, at 20° C., of less than about 0.0020 g/100 mL.

7. (canceled)

8. The method of claim 1, wherein the inorganic compound comprises up to about 750 ppm impurities.

9. The method of any one of claims claim 1, wherein the impurities of the inorganic compound comprise at least one of phosphorous-containing impurities, aluminum-containing impurities, iron-containing impurities, and boron-containing impurities.

10. The method of any claim 1, wherein the starting inorganic compound comprises at least about 100 ppm phosphorous-containing impurities.

11. (canceled)

12. The method of claim 7, wherein at least one of the impurities has a solubility in water, at 20° C., of greater than about 0.0025 g/100 mL.

13. The method of claim 1, wherein the washing of the inorganic compound with the aqueous solution comprises mixing the inorganic compound and the aqueous solution.

14. The method of claim 1, further comprising washing the purified inorganic compound with a second aqueous solution, to remove acid from the purified inorganic compound.

15-17. (canceled)

18. The method of claim 1, wherein the acid comprises at least one mineral acid.

19. The method of claim 1, wherein the acid comprises hydrogen chloride (HCl).

20-22. (canceled)

23. The method of claim 1, wherein the purified inorganic compound comprises less than about 10 ppm phosphorous-containing impurities.

24. (canceled)

25. The method of claim 1, wherein the purified inorganic compound is at least about 99.99 wt. % pure.

26-28. (canceled)

29. A method for purifying crystalline calcium fluoride (CaF₂) containing phosphorous-containing impurities, the method comprising washing the crystalline calcium fluoride (CaF₂) with an aqueous solution comprising acid, to remove at least some of the phosphorous-containing impurities from the crystalline calcium fluoride (CaF₂).

30. The method of claim 29, wherein the crystalline calcium fluoride (CaF₂) comprises at least about 100 ppm phosphorous-containing impurities.

31. The method of claim 29, wherein the aqueous solution acid is aqueous hydrochloric acid.

32. The method of claim 29, wherein the the acid is about 5-20 wt. % mineral acid.

33. The method of claim 29 or 30, wherein the aqueous solution is about 5-20 wt. % aqueous hydrochloric acid.

34. The method of claim 29, wherein the purified inorganic compound comprises up to about 10 ppm phosphorous-containing impurities.
